(19) United States
(12) Patent Application Publication
(10) Pub. No.: US 2026/0182509 A1
(43) Pub. Date: Jul. 2, 2026

(54) COMPOSITIONS, METHODS, AND SYSTEMS FOR RELATED TO HIGH-DENSITY VERTICAL FARMING

(71) Applicant: Beanstalk, Inc., Herndon, VA (US)

(72) Inventors: Jack L. Ross, Herndon, VA (US); Michael D. Ross, Herndon, VA (US)

(21) Appl. No.: 19/431,465

(22) Filed: Dec. 23, 2025

Related U.S. Application Data
(60) Provisional application No. 63/738,951, filed on Dec. 26, 2024.

(51) Int. Cl. A01G 31/00; A01G 9/02; A01G 24/15; A01G 24/23; A01G 31/02; A01G 31/06

(52) U.S. Cl. CPC A01G 31/011; A01G 9/02; A01G 24/15; A01G 24/23; A01G 31/023; A01G 31/06

(57) ABSTRACT

The present disclosure provides compositions, methods, and systems related to vertical farming. In particular, the present disclosure provides compositions, methods, and systems for growing high-density produce in a controlled hydroponic environment that obviates the need for fertilizers, pesticides, fungicides, or high-energy irrigation systems.

### CROSS REFERENCE TO RELATED APPLICATIONS

This application claims priority to and the benefit of U.S. Provisional Patent Application No. 63/738,951 filed Dec. 26, 2024, which is incorporated herein by reference in its entirety and for all purposes.

### FIELD

The present disclosure provides compositions, methods, and systems related to vertical farming. In particular, the present disclosure provides compositions, methods, and systems for growing high-density produce in a controlled hydroponic environment that obviates the need for fertilizers, pesticides, fungicides, or high-energy irrigation systems.

### BACKGROUND

Vertical farming is a technique that grows crops in stacked layers. It is commonly associated with hydroponics, which develop plants with minimal water usage, and without soil. Modern vertical farming developed from an experiment from a professor at the University of California in the 1930's and has since evolved into a $3.5 billion industry expected to continue growing in leaps and bounds over the next decade. One key benefit of vertical farming is that the entire environment is climate controlled. Compared with greenhouses, vertical farming typically offers significantly higher levels of climate control. While greenhouses utilize sunlight to cultivate plants and provide them with energy, its transparent enclosure subjects the interior climate to variations. Vertical farming operations generally use opaque enclosures that block natural sunlight and use artificial lighting instead. This results in controlled environmental agriculture, allowing for more efficient, sustainable and year-round food production. This allows growers to cultivate crops anywhere in the world-assuming access to stable power and water connections. Additionally, efficient and fast crop production is another advantage of vertical farming. By leveraging precision agriculture techniques, vertical farms accelerate crop growth cycles, resulting in faster harvest times compared to traditional farming. This efficiency extends to resource use, with vertical farms using significantly less water and land. Vertical farming also reduces the need for pesticides, leading to cleaner, healthier produce. Most importantly, studies suggest that crops grown in these conditions can have higher nutritional content. Thus, vertical farming not only enhances production speed and efficiency but also contributes to the cultivation of more nutritious crops.

Perhaps the largest challenge of vertical farming success is the high cost of energy that forms one of the industry's largest expenditures. As a result of vertical farming's highly efficient production, involving grow lights and electronic components, these systems require large amounts of electricity to operate. Energy costs are volatile compared to the price of other commodities, fluctuating depending on changes in supply and demand. This can result in increased insecurity when vertical farmers are planning economic projections for the future, dissuading investors and creditors from providing financial support to their operations. Additionally, vertical farms have significant complexities not immediately apparent to those unfamiliar with growing crops. It requires an understanding of plant biology, grow cycles, how crops respond to different climate conditions, pH and nutrient levels, and techniques to ensure efficient production and maximized yields. Because of vertical farming's compact environments, it's crucial to staff a hydroponic operation with skilled workers that understand how to alleviate problems when they arise.

Thus, vertical farming presents a promising solution to the challenges of traditional agriculture, offering increased yield, efficient resource use and the ability to grow crops in diverse climates. However, high energy costs, the need for skilled workers, and substantial initial investment are significant barriers to entry. Despite these challenges, the potential benefits of vertical farming make it a compelling avenue for the future of agriculture, if these challenges can be overcome.

### SUMMARY

Embodiments of the present disclosure include a method for high-density vertical farming. In accordance with these embodiments, the method includes obtaining at least one germinated plant, wherein the at least one germinated plant is housed in a first container with solid growth medium, and wherein a distal portion of the roots of the at least one germinated plant extend through the bottom of the first container; and positioning the first container and the at least one germinated plant relative to a second container with an aqueous growth medium such that an air gap is present between the bottom of the first container and a surface of the aqueous growth medium.

In some embodiments, the at least one germinated plant has been allowed to germinate for between about 2 and about 7 days.

In some embodiments, the distal portion of the roots of the at least one germinated plant is in contact with the aqueous growth medium in the second container or are less than 5 mm from contacting the aqueous medium in the second container.

In some embodiments, the distal portion of the roots of the at least one germinated plant extends from about 10 mm to about 50 mm below the bottom of the first container such that the zones of maturation of the roots are exposed to the air gap.

In some embodiments, the air gap formed between the bottom of the first container and the surface of the aqueous solution is from about 1 mm to about 50 mm. In some embodiments, the air gap formed between the bottom of the first container and the surface of the aqueous solution is from about 1 mm to about 10 mm. In some embodiments, the air gap formed between the bottom of the first container and the surface of the aqueous solution is from about 5 mm to about 10 mm.

In some embodiments, the solid growth medium is from about 2 cm to about 6 cm deep, and from about 1 cm to about 3 cm wide.

In some embodiments, a seed of the at least one germinated plant is placed at a predetermined depth in the solid growth medium prior to germination.

In some embodiments, the at least one germinated plant comprises a plurality of germinated plants, and wherein the seeds of the plurality of germinated plants were placed in the solid growth medium at approximately the same depth prior to germination.

In some embodiments, the air gap is maintained at a humidity level that is about 60% to about 100% relative humidity. In some embodiments, the air gap is maintained at a humidity level that is about 70% to about 95% relative humidity. In some embodiments, the air gap is maintained at a humidity level that is about 80% to about 90% relative humidity.

In some embodiments, the humidity level in the air gap is maintained during the growth cycle of the at least one germinated plant using seals that connect the first container to the second container.

In some embodiments, the air gap is maintained during the growth cycle of the at least one germinated plant, and wherein the growth cycle of the at least one germinated plant is from about 10 days to about 25 days.

In some embodiments, the aqueous growing medium comprises an oxygen level that is 10 ppm or less. In some embodiments, the aqueous growing medium comprises an oxygen level that is less than 8 ppm. In some embodiments, the aqueous growing medium comprises an oxygen level that is less than 4 ppm.

In some embodiments, oxygen is not added to the aqueous growth medium.

In some embodiments, the aqueous growth medium comprises a pH from about 5.0 to about 8.0. In some embodiments, the aqueous growth medium comprises a pH from about 6.0 to about 7.0. In some embodiments, the aqueous growth medium comprises a pH from about 6.5 to about 7.5.

In some embodiments, the aqueous growth medium comprises at least one salt, buffer, nutrient, vitamin, mineral, and/or growth regulator.

In some embodiments, the aqueous growth medium is not circulated, recirculated, or agitated during growth of the at least one germinated plant. In some embodiments, the aqueous growth medium is static during growth of the at least one germinated plant.

In some embodiments, the solid growth medium comprises at least one salt, buffer, nutrient, vitamin, mineral, and/or growth regulator.

In some embodiments, the solid growth medium comprises a wetting agent. In some embodiments, the wetting agent comprises at least one of perlite, vermiculite, coconut coir, a hydrogel, and/or wood fiber.

In some embodiments, the solid growth medium comprises a fungal agent. In some embodiments, the fungal agent comprises at least one of mycorrhizal fungi and/or Trichoderma harzianum fungi.

In some embodiments, the solid growth medium comprises at least one additional component selected from biochar, composted organic matter, and/or beneficial bacteria.

In some embodiments, the second container is comprised of material that reduces light exposure.

In some embodiments, the ambient temperature surrounding the first container and the second container is maintained at about 15° C. to about 25° C. In some embodiments, the ambient temperature surrounding the first container and the second container is maintained at about 18° C. to about 24° C.

In some embodiments, the method further comprises replacing and/or replenishing the aqueous growth medium at least once during growth of the at least one germinated plant. In some embodiments, the aqueous growth medium is replaced and/or replenished with the same growth medium during growth of the at least one germinated plant. In some embodiments, the aqueous growth medium is replaced and/or replenished with a different growth medium during growth of the at least one germinated plant.

In some embodiments, the method further comprises transferring the at least one germinated plant to at least a third container containing aqueous growth medium. In some embodiments, the at least third container comprises the same aqueous growth medium. In some embodiments, the at least third container comprises different aqueous growth medium.

In some embodiments, the method further comprises assessing at least one growth parameter during growth of the at least one germinated plant.

In some embodiments, the method further comprises harvesting the at least one germinated plant when a desired growth outcome is reached.

In some embodiments, the at least one germinated plant is selected from the group consisting of: bok choy, pac choi, lettuce, spinach, chard, kale, arugula, mustard greens, fennel, basil, chives, mint, parsley, cilantro, tomatoes, cucumbers, broccoli, peas, strawberries, rice, quinoa, mushrooms, and/or flowering plants.

### BRIEF DESCRIPTION OF THE DRAWINGS

FIG. 1: Representative image of a container housing a plurality of germinated plants, wherein the roots extend about 10 mm to about 30 mm from the bottom of the container, according to one embodiment of the present disclosure.

FIG. 2: Representative image of a plurality of germinated plants covered by a tarp that ensures a high degree of humidity until cotyledons are formed, at which point the tarp is removed, according to one embodiment of the present disclosure.

FIGS. 3A-3C: Representative image of root hairs extending from the bottom of a container housing a plurality of germinated plants and into aqueous growing medium (approximately day 7 of the growing cycle), according to one embodiment of the present disclosure (FIG. 3A). Oxygen-consuming roots (zone of maturation) are present above the water line in the air gap. FIG. 3B is a partial cross-sectional view representative of one stage of the growing cycle, illustrating a tray with a germinated plant having roots extending through a bottom of the tray into an aqueous growth medium. FIG. 3C is a partial cross-sectional view of FIG. 3B, representative of another later stage of the growing cycle.

FIG. 4: Representative image of the roots of a plurality of germinated plants separated from the container housing aqueous growth medium, according to one embodiment of the present disclosure. Oxygen-consuming roots (proximally located fuzzy white roots) expand as the aqueous growth medium is consumed by the roots and the water level lowers; this exposes the proximal portions of the roots (zone of maturation) to the air gap and accelerates growth of the plants. The distal portion of the roots are submerged in the aqueous medium (darker in color).

FIG. 5: Representative image of the unexpectedly high degree of expansion of the oxygen-consuming roots (proximally located fuzzy white roots) that expand as the aqueous growth medium is consumed by the roots and the water level lowers (approximately day 14 of the growing cycle), according to one embodiment of the present disclosure. This exposes the proximal portions of the roots (zone of maturation) to the air gap and accelerates growth of the plants.

FIG. 6: Representative image of various crops at the time of harvest (approximately day 21 of the growing cycle), according to one embodiment of the present disclosure. This demonstrates the unexpectedly high density of crops that can be sustainably grown using the systems and methods of the present disclosure.

FIGS. 7A-7B: Representative image of an isolated container of infected spinach plants among containers of non-infected spinach plants (FIG. 7A), according to one embodiment of the present disclosure. Representative quantitative and qualitative results of the degree of fungal pathogen infection assessed using DMA Multiscan technology (FIG. 7B). Significantly higher levels of the infectant are present in the container of P. aphanidermatum as compared to the other plants/containers. However, this infection did not spread to adjacent containers due to the use of the systems and methods of the present disclosure.

FIG. 8 is a perspective view of a lid and a basin, according to one embodiment of the present disclosure.

FIG. 9 is a perspective view of a vertical farming system, according to one embodiment of the present disclosure.

### DETAILED DESCRIPTION

Embodiments of the present disclosure include compositions, methods, and systems related to vertical farming. In particular, the present disclosure provides compositions, methods, and systems for growing high-density produce in a controlled hydroponic environment that obviates the need for fertilizers, pesticides, fungicides, or high-energy irrigation systems. As described further herein, the methods and systems of the present disclosure include automated vertical farming facilities comprising various hydroponic systems capable of producing any crop in a manner that is more sustainable and efficient compared to currently used vertical farming methods and systems. The technology described herein provides substantial cost advantages relative to traditional organic growers and competing vertical farms by creating a highly controlled environment and optimal growing conditions for any crop, which allows for the selection of seeds and plant varieties optimized for nutrition and taste rather than crop resilience.

The systems and methods of the present disclosure include the use of palletized hydroponic systems that enable the conversion of traditional warehouses into efficient vertical growing facilities. These facilities can be developed for roughly one-tenth the cost of competing vertical farms and are able to grow more produce per square foot than any field, greenhouse, or vertical farming competitor. Given this efficient, low-cost structure, the technology described herein enables the development of economically feasible facilities in close proximity to major metropolitan areas and grocery fulfillment centers. Additionally, because no fertilizers, pesticides, fungicides, or other treatments are used in the growing process, the produce grown using the methods and systems of the present disclosure do not require washing prior to packaging. By obviating the need for washing (which tends to damage leafy greens and creates high-moisture conditions that facilitate bacteria growth), the technology of the present disclosure is able to deliver a more robust and longer lasting product, with a lower cost structure than competing vertical farms and traditional organic growers. In particular, the development of vertical farming methods and systems that do not require high-energy irrigation systems or circulating water for growing crops (termed “hydrostatic cultivation”) reduced cost by over 10× compared to currently available vertical farming systems. And with the development of advanced automation, the technology of the present disclosure is able to achieve the lowest cost per pound in commodity greens and herbs, while growing 50% faster than the field grown crops.

Additionally, for example, analysis of published data indicates that the systems and methods of the present disclosure provide superior annual yields compared to other indoor forming systems and even outdoor systems that use pesticides. Due to decreased grow times per crop, as well as increased yields per crop increased and crops per year, the systems and methods of the present disclosure provide a significantly greater annual yield (lb/ft2/yr) as compared to greenhouse systems and an outdoor system that uses pesticides. Importantly, the systems and methods of the present disclosure do not have to rely on any pesticides, insecticides, or fungicides to achieve these superior results.

TABLE 1
Comparative Yield Analysis for Spinach

| | | Grow | | Yield | | Annual | |
|---|---|---|---|---|---|---|---|
| | | Time/ | Yield/ | (lb/ft²/ | Crops/ | Yield | |
| System | Environment | Crop | Crop | crop) | Yr | (lb/ft²/yr) | Source |
| Beanstalk | Fully indoor, | 18 days | 3.5 lb | 0.52 | 20.3 | 10.56 | Internal production |
| (present | sealed | | per | | | | |
| disclosure) | | | tray | | | | |
| Oklahoma | Greenhouse | 52 days | 2093 | 0.43 | ~7 | ~3.0 | researchgate.net/ |
| greenhouse - | float-bed | | g/m² | | | | publication/287631919_{—} |
| Fall | | | | | | | Yield_and_Quality_of_{—} |
| | | | | | | | Spinach_Cultivars_for_{—} |
| | | | | | | | Greenhouse_Production_{—} |
| | | | | | | | in_Oklahoma |
| Oklahoma | Greenhouse | 37 days | 1649 | 0.34 | ~9.9 | ~3.4 | researchgate.net/ |
| greenhouse - | float-bed | | g/m² | | | | publication/287631919_{—} |
| Spring | | | | | | | Yield_and_Quality_of_{—} |
| | | | | | | | Spinach_Cultivars_for_{—} |
| | | | | | | | Greenhouse_Production_{—} |
| | | | | | | | in_Oklahoma |
| Outdoor field | Open field | ~40-60 | 10-12 | 0.46-0.55 | 3 | 1.38-1.65 | nevegetable.org/crops/ |
| | (with | days | tons/ | | | | spinach |
| | pesticides) | | acre | | | | |

Section headings as used in this section and the entire disclosure herein are merely for organizational purposes and are not intended to be limiting.

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The term “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term. For example, in some embodiments, it will mean plus or minus 5% of the particular term. Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number therebetween with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

“Correlated to” as used herein refers to compared to.

As used herein, the term “variety” refers to a population of plants that share constant characteristics which separate them from other plants of the same species. A variety is often, although not always, sold commercially. While possessing one or more distinctive traits, a variety is further characterized by a very small overall variation between individuals within that variety. A “pure line” variety may be created by several generations of self-pollination and selection, or vegetative propagation from a single parent using tissue or cell culture techniques. A variety can be essentially derived from another line or variety. As defined by the International Convention for the Protection of New Varieties of Plants (Dec. 2, 1961, as revised at Geneva on Nov. 10, 1972; on Oct. 23, 1978; and on Mar. 19, 1991), a variety is “essentially derived” from an initial variety if: a) it is predominantly derived from the initial variety, or from a variety that is predominantly derived from the initial variety, while retaining the expression of the essential characteristics that result from the genotype or combination of genotypes of the initial variety; b) it is clearly distinguishable from the initial variety; and c) except for the differences which result from the act of derivation, it conforms to the initial variety in the expression of the essential characteristics that result from the genotype or combination of genotypes of the initial variety. Essentially derived varieties can be obtained, for example, by the selection of a natural or induced mutant, a somaclonal variant, a variant individual from plants of the initial variety, backcrossing, or transformation. As used herein, “elite variety” means any variety that has resulted from breeding and selection for superior agronomic performance.

As used herein, “selecting” or “selection” in the context of marker-assisted selection or breeding refer to the act of picking or choosing desired individuals, normally from a population, based on certain pre-determined criteria.

As used herein, the term “trait” refers to one or more detectable characteristics of a cell or organism which can be influenced by genotype. The phenotype can be observable to the naked eye, or by any other means of evaluation known in the art, e.g., microscopy, biochemical analysis, genomic analysis, an assay for a particular disease tolerance, etc. In some cases, a phenotype is directly controlled by a single gene or genetic locus, e.g., a “single gene trait.” In other cases, a phenotype is the result of several genes.

The term “plant” as used herein encompasses a whole plant, a grafted plant, ancestor(s) and progeny of the plants and plant parts, including seeds, shoots, stems, roots (including tubers), rootstock, scion, and plant cells, tissues and organs. The plant may be in any form including suspension cultures, embryos, meristematic regions, callus tissue, leaves, gametophytes, sporophytes, pollen, and microspores.

The term “zone of maturation” as used herein generally refers to the portion of the roots of a plant where elongating cells complete their differentiation into the tissues of the primary body. It is easily recognized because of the numerous root hairs that extend outward as outgrowths of single epidermal cells. They greatly increase the absorptive surface of roots during the growth period when large amounts of water and nutrients are needed. An individual root hair lives for only a day or two, but new ones form constantly nearer the tip as old ones die in the upper part of the zone. In some embodiments, the “root zone of maturation” refers to the section of a plant root where newly formed cells differentiate into specialized cell types, including root hairs, and essentially reach their final function, marking the stage where the root is fully mature and ready to absorb water and nutrients from the soil; it is also sometimes called the “differentiation zone” or “root hair zone” because this is where most root hairs develop. As described further herein, exposure of the zone of maturation of the roots of a plant to an air gap comprising a certain humidity level after germination significantly increases root hair growth, and consequently, plant growth, as compared to submerging the entire root system in water.

Unless otherwise defined herein, scientific and technical terms used in connection with the present disclosure shall have the meanings that are commonly understood by those of ordinary skill in the art. For example, any nomenclatures used in connection with, and techniques of, cell and tissue culture, molecular biology, plant biology, genetics and protein and nucleic acid chemistry and hybridization described herein are those that are well known and commonly used in the art. The meaning and scope of the terms should be clear; in the event, however of any latent ambiguity, definitions provided herein take precedent over any dictionary or extrinsic definition. Further, unless otherwise required by context, singular terms shall include pluralities and plural terms shall include the singular.

### 2. COMPOSITIONS AND METHODS

The present disclosure provides compositions, methods, and systems related to vertical farming. In particular, the present disclosure provides compositions, methods, and systems for growing high-density produce in a controlled hydroponic environment that obviates the need for fertilizers, pesticides, fungicides, or high-energy irrigation systems.

In accordance with this, embodiments of the present disclosure include a method for high-density vertical farming. In some embodiments, the method includes obtaining at least one germinated plant (e.g., of a plurality of germinated plants in a vertical farming system) that is housed in a first container with solid growth medium. In some embodiments, the distal portion of the roots of the at least one germinated plant extends through the bottom of the first container. In some embodiments, the method also includes positioning the first container and the at least one germinated plant relative to a second container with an aqueous growth medium, such that an air gap is present between the bottom of the first container and a surface of the aqueous growth medium.

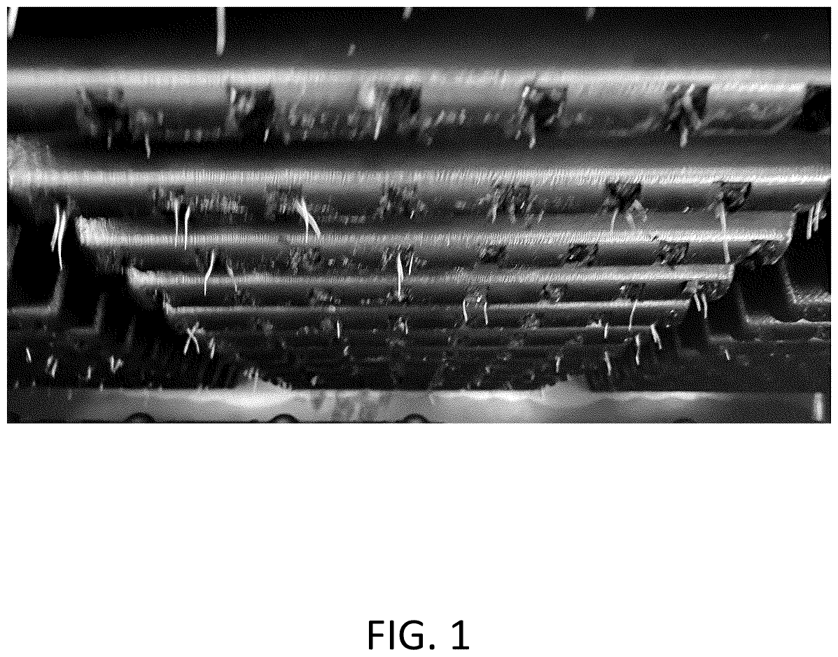

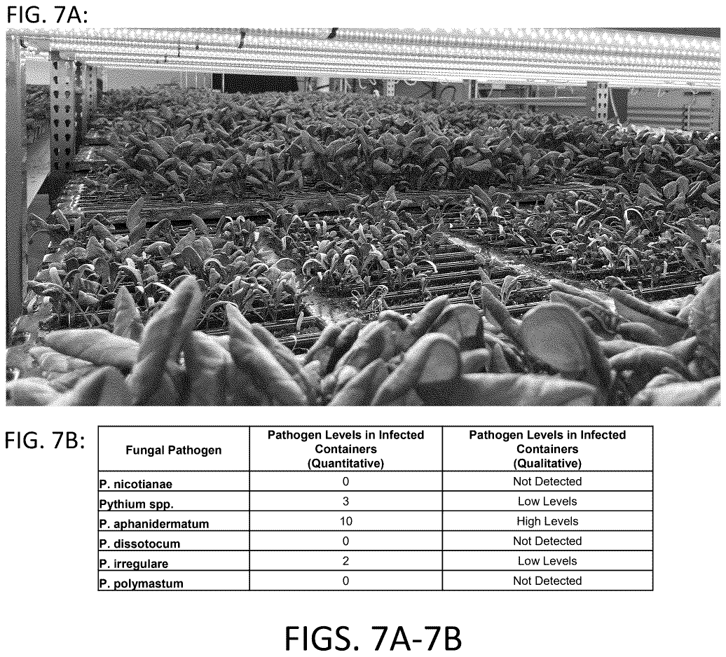

As described further herein (see, e.g., Example 1 and FIGS. 1-6), exposing the proximal portions of the roots of the plants (i.e., the zone of maturation) to an air gap above the aqueous growth medium surprisingly and unexpectedly stimulates the growth of hair cells (e.g., due to the higher oxygen levels in the air as compared to the aqueous growth medium), which in turn, accelerates the growth of the plants (e.g., as compared to plants grown in a conventional vertical farming system (e.g., hydroponic system)). As the plants grow, the air gap generally increases as the plants absorb the aqueous growth medium until the plants reach the point of harvest. However, in some embodiments the air gap can be maintained at a given size throughout growth of the plants (e.g., by adding aqueous growth medium). Additionally, as described further herein (see, e.g., Example 2 and FIGS. 7A-7B), the systems and methods of the present disclosure do not require circulating, re-circulating, or agitating the water (e.g., aqueous growth medium) in any manner (hydrostatic cultivation). In this manner, the systems and methods of the present disclosure prevent and/or mitigate the spread of disease throughout the system. For example, the results shown in FIG. 7B demonstrate that the methods of the present disclosure significantly reduce levels of infection by various fungal pathogens in spinach plants by growing the plants in isolated trays and not circulating water among the trays, which prevents the spread of pathogens via the circulating water from one tray to another. In some embodiments, the methods and systems of the present disclosure facilitate the growth of various plants, such as spinach plants, without the use of pesticides, fungicides, or insecticides (i.e., organically).

In accordance with the above, in some embodiments, the at least one germinated plant has been allowed to germinate for between about 2 and about 7 days before being placed into the system. In some embodiments, the at least one germinated plant has been allowed to germinate for between about 2 and about 6 days before being placed into the system. In some embodiments, the at least one germinated plant has been allowed to germinate for between about 2 and about 5 days before being placed into the system. In some embodiments, the at least one germinated plant has been allowed to germinate for between about 2 and about 4 days before being placed into the system. In some embodiments, the at least one germinated plant has been allowed to germinate for between about 2 and about 3 days before being placed into the system. In some embodiments, the at least one germinated plant has been allowed to germinate for between about 3 and about 7 days before being placed into the system. In some embodiments, the at least one germinated plant has been allowed to germinate for between about 4 and about 7 days before being placed into the system. In some embodiments, the at least one germinated plant has been allowed to germinate for between about 5 and about 7 days before being placed into the system. In some embodiments, the at least one germinated plant has been allowed to germinate for between about 6 and about 7 days before being placed into the system. In some embodiments, the at least one germinated plant has been allowed to germinate for between about 4 and about 6 days before being placed into the system. In some embodiments, the at least one germinated plant has been allowed to germinate for between about 3 and about 5 days before being placed into the system. In some embodiments, the at least one germinated plant has been allowed to germinate for between about 4 and about 5 days before being placed into the system.

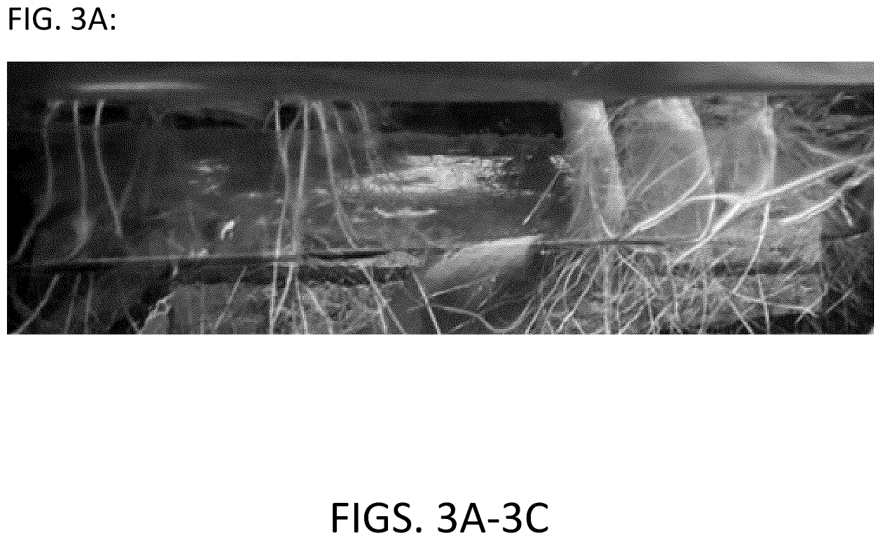

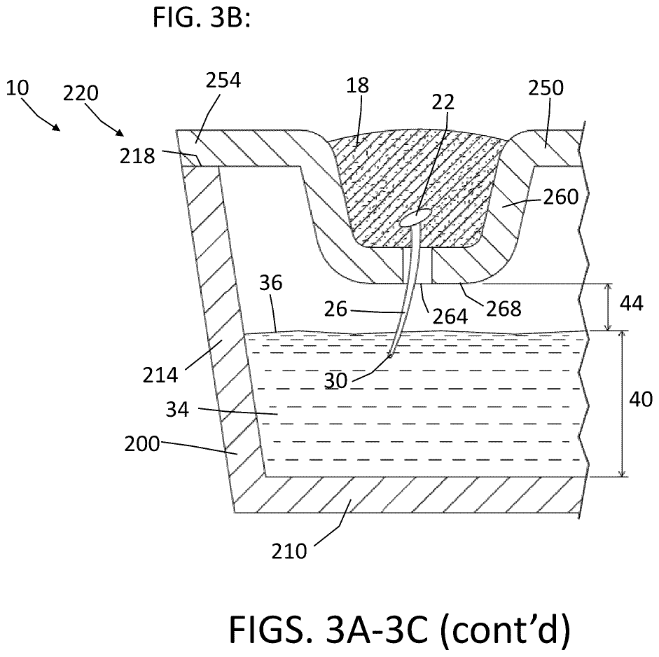

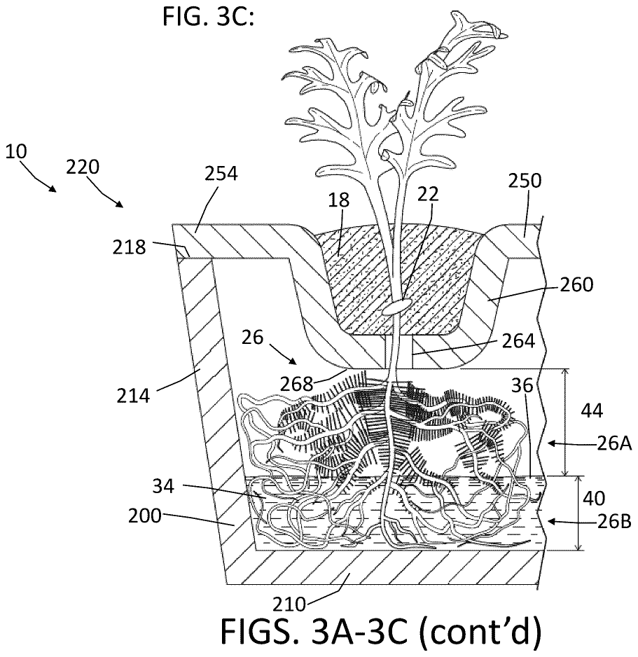

As described further in FIGS. 3A-3C, the systems and methods of the present disclosure include positioning the distal portion of the roots of the germinated plants such that they are in contact with aqueous growth medium in a second container positioned below the first container. In some embodiments, the distal portion of the roots are less than 5 mm from contacting the aqueous medium in the second container. In some embodiments, the distal portion of the roots are less than 4 mm from contacting the aqueous medium in the second container. In some embodiments, the distal portion of the roots are less than 3 mm from contacting the aqueous medium in the second container. In some embodiments, the distal portion of the roots are less than 2 mm from contacting the aqueous medium in the second container. In some embodiments, the distal portion of the roots are less than 1 mm from contacting the aqueous medium in the second container.

In accordance with these embodiments, the distal portion of the roots of the germinated plants extend from about 10 mm to about 50 mm below the bottom of the first container such that the zones of maturation of the roots are exposed to the air gap (see, e.g., Example 1). In some embodiments, the distal portion of the roots of the germinated plants extend from about 10 mm to about 40 mm below the bottom of the first container. In some embodiments, the distal portion of the roots of the germinated plants extend from about 10 mm to about 30 mm below the bottom of the first container. In some embodiments, the distal portion of the roots of the germinated plants extend from about 10 mm to about 20 mm below the bottom of the first container. In some embodiments, the distal portion of the roots of the germinated plants extend from about 20 mm to about 50 mm below the bottom of the first container. In some embodiments, the distal portion of the roots of the germinated plants extend from about 30 mm to about 50 mm below the bottom of the first container. In some embodiments, the distal portion of the roots of the germinated plants extend from about 40 mm to about 50 mm below the bottom of the first container. In some embodiments, the distal portion of the roots of the germinated plants extend from about 30 mm to about 40 mm below the bottom of the first container. In some embodiments, the distal portion of the roots of the germinated plants extend from about 25 mm to about 35 mm below the bottom of the first container. In some embodiments, the distal portion of the roots of the germinated plants extend from about 15 mm to about 30 mm below the bottom of the first container.

In some embodiments, the air gap formed between the bottom of the first container and the surface of the aqueous solution, as illustrated in FIGS. 3A-3C, is from about 1 mm to about 50 mm. In some embodiments, the air gap formed between the bottom of the first container and the surface of the aqueous solution is from about 1 mm to about 40 mm. In some embodiments, the air gap formed between the bottom of the first container and the surface of the aqueous solution is from about 1 mm to about 30 mm. In some embodiments, the air gap formed between the bottom of the first container and the surface of the aqueous solution is from about 1 mm to about 20 mm. In some embodiments, the air gap formed between the bottom of the first container and the surface of the aqueous solution is from about 1 mm to about 10 mm. In some embodiments, the air gap formed between the bottom of the first container and the surface of the aqueous solution is from about 10 mm to about 50 mm. In some embodiments, the air gap formed between the bottom of the first container and the surface of the aqueous solution is from about 20 mm to about 50 mm. In some embodiments, the air gap formed between the bottom of the first container and the surface of the aqueous solution is from about 30 mm to about 50 mm. In some embodiments, the air gap formed between the bottom of the first container and the surface of the aqueous solution is from about 40 mm to about 50 mm. In some embodiments, the air gap formed between the bottom of the first container and the surface of the aqueous solution is from about 20 mm to about 40 mm. In some embodiments, the air gap formed between the bottom of the first container and the surface of the aqueous solution is from about 10 mm to about 30 mm. In some embodiments, the air gap formed between the bottom of the first container and the surface of the aqueous solution is from about 20 mm to about 30 mm.

In some embodiments, the air gap formed between the bottom of the first container and the surface of the aqueous solution is from about 5 mm to about 10 mm. In some embodiments, the air gap formed between the bottom of the first container and the surface of the aqueous solution is from about 5 mm to about 9 mm. In some embodiments, the air gap formed between the bottom of the first container and the surface of the aqueous solution is from about 5 mm to about 8 mm. In some embodiments, the air gap formed between the bottom of the first container and the surface of the aqueous solution is from about 5 mm to about 7 mm. In some embodiments, the air gap formed between the bottom of the first container and the surface of the aqueous solution is from about 5 mm to about 6 mm. In some embodiments, the air gap formed between the bottom of the first container and the surface of the aqueous solution is from about 6 mm to about 10 mm. In some embodiments, the air gap formed between the bottom of the first container and the surface of the aqueous solution is from about 7 mm to about 10 mm. In some embodiments, the air gap formed between the bottom of the first container and the surface of the aqueous solution is from about 8 mm to about 10 mm. In some embodiments, the air gap formed between the bottom of the first container and the surface of the aqueous solution is from about 9 mm to about 10 mm. In some embodiments, the air gap formed between the bottom of the first container and the surface of the aqueous solution is from about 6 mm to about 8 mm. In some embodiments, the air gap formed between the bottom of the first container and the surface of the aqueous solution is from about 7 mm to about 9 mm.

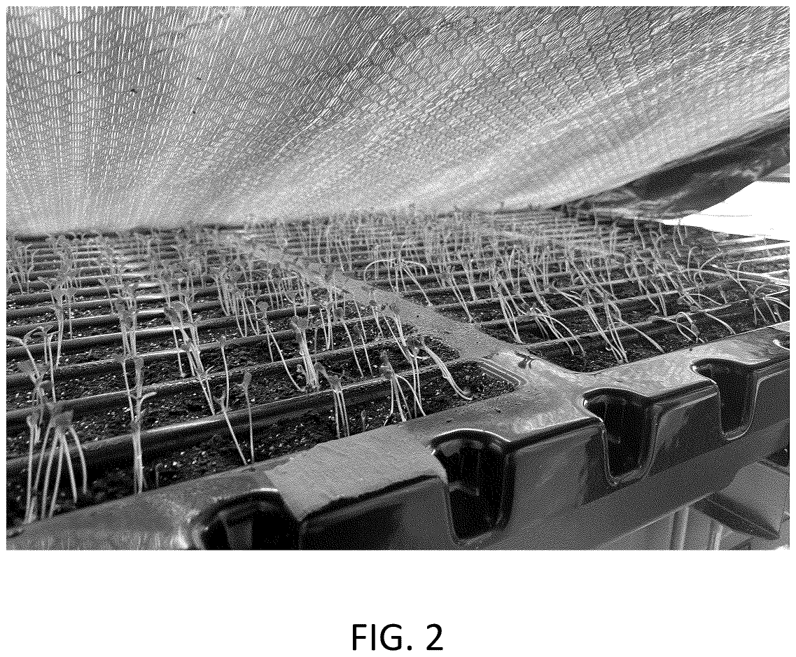

As described further herein and illustrated in FIGS. 1 and 2, the systems and methods of the present disclosure include solid growth medium in which the germinated plants are initially planted and subsequently germinated. The solid growth medium is present in the first container. In some embodiments, the solid growth medium is from about 2 cm to about 6 cm deep, and from about 1 cm to about 3 cm wide, though the depth and width of the solid growth medium can vary depending on the requirements of the particular plants being grown. In some embodiments, the solid growth medium comprises at least one salt, buffer, nutrient, vitamin, mineral, and/or growth regulator. In some embodiments, the solid growth medium comprises a wetting agent. In some embodiments, the wetting agent comprises at least one of perlite, vermiculite, coconut coir, a hydrogel, and/or wood fiber. In some embodiments, the solid growth medium comprises a fungal agent. In some embodiments, the fungal agent comprises at least one of mycorrhizal fungi and/or Trichoderma harzianum fungi. In some embodiments, the solid growth medium comprises at least one additional component selected from biochar, composted organic matter, and/or beneficial bacteria. As would be appreciated by one of ordinary skill in the art based on the present disclosure, the precise components included in solid growth media will depend on the type of plants being grown and their corresponding nutrient requirements.

In some embodiments, a seed of the at least one germinated plant was placed at a predetermined depth in the solid growth medium prior to germination. In some embodiments, the at least one germinated plant comprises a plurality of germinated plants (see, e.g., FIGS. 1 and 2), and wherein the seeds of the plurality of germinated plants were placed in the solid growth medium at approximately the same depth prior to germination, such that root extension of the germinated plants from the bottom of the first container is substantially coordinated.

As described further in Example 1, an air gap between the bottom of the first container and a surface of the aqueous growth medium is maintained during growth of the germinated plants and up until harvest. Various aspects of the air gap are controlled according to system parameters. For example, in some embodiments, the humidity level in the air gap is maintained during the growth cycle of the at least one germinated plant using seals that connect the first container to the second container (see, e.g., FIG. 2). In some embodiments, the air gap is maintained at a humidity level that is about 60% to about 100% relative humidity. In some embodiments, the air gap is maintained at a humidity level that is about 60% to about 90% relative humidity. In some embodiments, the air gap is maintained at a humidity level that is about 60% to about 80% relative humidity. In some embodiments, the air gap is maintained at a humidity level that is about 60% to about 70% relative humidity. In some embodiments, the air gap is maintained at a humidity level that is about 70% to about 100% relative humidity. In some embodiments, the air gap is maintained at a humidity level that is about 80% to about 100% relative humidity. In some embodiments, the air gap is maintained at a humidity level that is about 90% to about 100% relative humidity. In some embodiments, the air gap is maintained at a humidity level that is about 80% to about 90% relative humidity. In some embodiments, the air gap is maintained at a humidity level that is about 75% to about 90% relative humidity. In some embodiments, the air gap is maintained at a humidity level that is about 70% to about 95% relative humidity. In some embodiments, the air gap is maintained at a humidity level that is about 80% to about 95% relative humidity. In some embodiments, the air gap is maintained at a humidity level that is about 65% to about 85% relative humidity. In some embodiments, the air gap is maintained at a humidity level that is about 70% to about 85% relative humidity.

In some embodiments, the air gap is maintained during the growth cycle of the germinated plants, wherein the growth cycle of the at least one germinated plant is from about 10 days to about 25 days. In some embodiments, the growth cycle of the at least one germinated plant is from about 10 days to about 20 days. In some embodiments, the growth cycle of the at least one germinated plant is from about 10 days to about 15 days. In some embodiments, the growth cycle of the at least one germinated plant is from about 15 days to about 25 days. In some embodiments, the growth cycle of the at least one germinated plant is from about 20 days to about 25 days. In some embodiments, the growth cycle of the at least one germinated plant is from about 15 days to about 20 days. As would be appreciated by one of ordinary skill in the art based on the present disclosure, the precise number of days in a growth cycle will depend on the type of plants being grown. However, generally, and as described further herein, the systems and methods of the present disclosure accelerate the growth of plants grown in conventional (e.g., hydroponic) vertical farming systems (see, e.g., Example 1).

As described further herein, the systems and methods of the present disclosure include aqueous growth medium in a second container to which the roots of the germinated plants extend during growth (see, e.g., FIG. 3A). In some embodiments, the second container is comprised of material that reduces light exposure. Generally, the aqueous growth medium contained in the second container includes components necessary to support growth of the plants, and as the plants grow, they absorb the nutrients from the aqueous growth medium (which can increase the size of the air gap).

For example, in some embodiments, the aqueous growing medium comprises an oxygen level that is 10 ppm or less. In some embodiments, the aqueous growing medium comprises an oxygen level that is less than 8 ppm. In some embodiments, the aqueous growing medium comprises an oxygen level that is less than 4 ppm. In some embodiments, the aqueous growing medium comprises an oxygen level that is less than 3 ppm. In some embodiments, the aqueous growing medium comprises an oxygen level that is less than 2 ppm. In some embodiments, the aqueous growing medium comprises an oxygen level that is less than 1 ppm. In some embodiments, the aqueous growing medium comprises an oxygen level that is from about 4 ppm to about 10 ppm. In some embodiments, the aqueous growing medium comprises an oxygen level that is from about 4 ppm to about 8 ppm. In some embodiments, the aqueous growing medium comprises an oxygen level that is from about 4 ppm to about 6 ppm. In some embodiments, the aqueous growing medium comprises an oxygen level that is from about 6 ppm to about 10 ppm. In some embodiments, the aqueous growing medium comprises an oxygen level that is from about 8 ppm to about 10 ppm. In some embodiments, the aqueous growing medium comprises an oxygen level that is from about 5 ppm to about 7 ppm. In some embodiments, the aqueous growing medium comprises an oxygen level that is from about 6 ppm to about 9 ppm. In some embodiments, the aqueous growing medium comprises an oxygen level that is from about 4 ppm to about 7 ppm. In some embodiments, the aqueous growing medium comprises an oxygen level that is from about 7 ppm to about 9 ppm.

Additionally, at least in part due to the inclusion of an air gap, the systems and methods of the present disclosure are distinct from conventional hydroponic vertical farming systems in which no air gap is included, and which require oxygen to be added to the recirculating water systems in order to sustain growth of the plants. Generally, hydroponic systems require dissolved oxygen levels in the water to be maintained at about 8 ppm. Some crops, such as spinach, will only grow satisfactorily if dissolved oxygen levels in the water are at least 4 ppm (see, e.g., Cornell Controlled Environmental Agriculture: Hydroponic Spinach Production Handbook; Brechner and de Villiers, 2013, Cornell University CEA Program). If additional oxygen is not added to the system, dissolved oxygen levels will drop to nearly 0 ppm, and the absence of oxygen in the nutrient solution will stop the process of respiration and seriously damage and kill the plant. To prevent this, pure oxygen is added to the recirculation system. However, in contrast, the systems and methods of the present disclosure are able to sustain plant growth at oxygen levels below 8 ppm. That is, the systems and methods of the present disclosure to not require oxygen to be added to the aqueous growth medium at all, at least in part due to the surprising and unexpected discovery that inclusion of an air gap stimulates the growth of hair cells (e.g., due to the higher oxygen levels in the air as compared to the aqueous growth medium), which in turn, accelerates the growth of the plants. As described further herein, the aqueous growth medium of the present disclosure is not circulated, recirculated, or agitated during growth of the germinated plants. In some embodiments, the aqueous growth medium is static during growth of the at least one germinated plant (e.g., hydrostatic cultivation).

In some embodiments, the aqueous growth medium comprises a pH from about 5.0 to about 8.0. In some embodiments, the aqueous growth medium comprises a pH from about 6.0 to about 7.0. In some embodiments, the aqueous growth medium comprises a pH from about 6.5 to about 7.5. In some embodiments, the aqueous growth medium comprises at least one salt, buffer, nutrient, vitamin, mineral, and/or growth regulator. As would be appreciated by one of ordinary skill in the art based on the present disclosure, the precise components included in aqueous growth media will depend on the type of plants being grown and their corresponding nutrient requirements.

In some embodiments, the system parameters that are controlled during the growth cycle of the plants include ambient temperature. In some embodiments, the ambient temperature surrounding the first container and the second container is maintained at about 15° C. to about 25° C. In some embodiments, the ambient temperature surrounding the first container and the second container is maintained at about 15° C. to about 24° C. In some embodiments, the ambient temperature surrounding the first container and the second container is maintained at about 15° C. to about 22° C. In some embodiments, the ambient temperature surrounding the first container and the second container is maintained at about 15° C. to about 20° C. In some embodiments, the ambient temperature surrounding the first container and the second container is maintained at about 15° C. to about 18° C. In some embodiments, the ambient temperature surrounding the first container and the second container is maintained at about 17° C. to about 24° C. In some embodiments, the ambient temperature surrounding the first container and the second container is maintained at about 20° C. to about 24° C. In some embodiments, the ambient temperature surrounding the first container and the second container is maintained at about 22° C. to about 24° C. In some embodiments, the ambient temperature surrounding the first container and the second container is maintained at about 18° C. to about 24° C. In some embodiments, the ambient temperature surrounding the first container and the second container is maintained at about 18° C. to about 21° C. In some embodiments, the ambient temperature surrounding the first container and the second container is maintained at about 16° C. to about 20° C.

In accordance with the above embodiments, the systems and methods of the present disclosure include replacing and/or replenishing the aqueous growth medium at least once during growth of the plants. In some embodiments, the aqueous growth medium is replaced and/or replenished with the same growth medium during growth of the plants. In some embodiments, the aqueous growth medium is replaced and/or replenished with a different growth medium during growth of the plants.

In some embodiments, the systems and methods of the present disclosure include transferring the plants to at least a third container containing aqueous growth medium. In some embodiments, the third container comprises the same aqueous growth medium. In some embodiments, the third container comprises different aqueous growth medium. In some embodiments, the plants are transferred to a fourth or fifth container containing aqueous growth medium, depending on the length cycle of the plants being grown.

As the plants are grown using the systems and methods of the present disclosure, the method can further include assessing at least one growth parameter during growth of the plants. Growth parameters that can be assessed include, but are not limited to, measuring leaf surface area, measuring plant height, measuring one or more plant metabolites, measuring a level of a gas (e.g., oxygen, carbon dioxide, nitrogen), assessing the plants for the presence/absence of a disease or pathogen, and the like. In some embodiments, the method further includes harvesting the plants when a desired growth parameter or outcome is achieved.

As one of ordinary skill in the art would acknowledge based on the present disclosure, the systems and methods described herein can be used to grow and cultivate any type of plant. Although various alterations may be required to apply the disclosed systems and methods to a certain type of plant, the systems and methods of the present disclosure are designed to be flexible and adaptable to suit the needs of any plant species. In some embodiments, the at least one germinated plant that can be grown using the systems and methods of the present discourse includes, but is not limited to, bok choy, pac choi, lettuce, spinach, chard, kale, arugula, mustard greens, fennel, basil, chives, mint, parsley, cilantro, tomatoes, cucumbers, broccoli, peas, strawberries, rice, quinoa, mushrooms, and/or flowering plants.

### 3. SYSTEMS

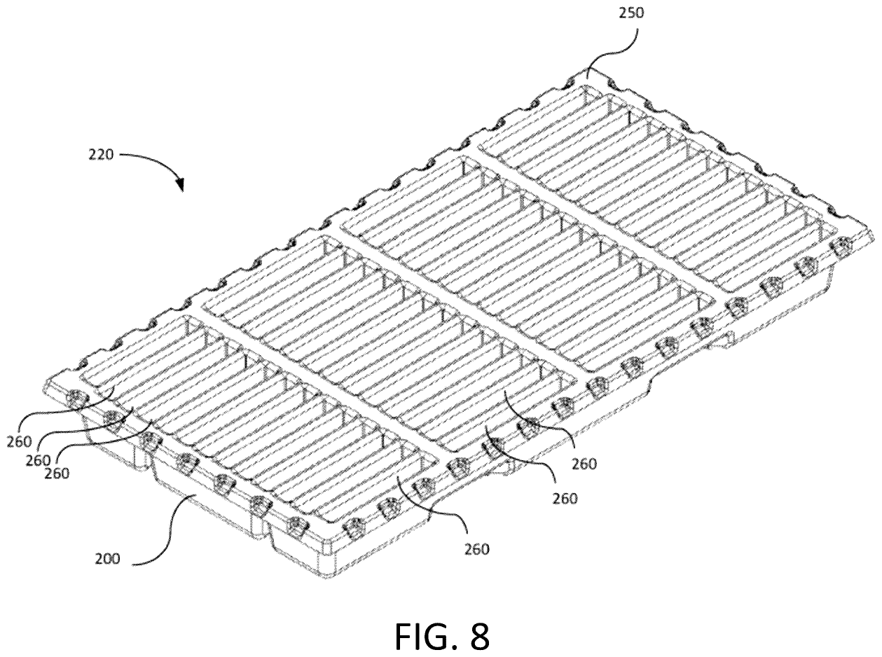

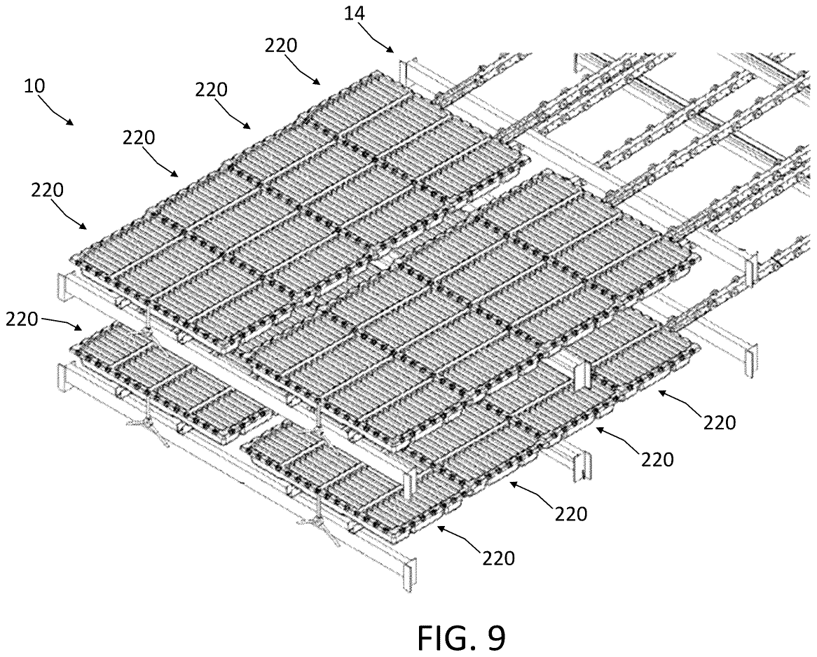

With reference to FIGS. 8 and 9, a growing system 10 includes at least one container assembly 220 including a tray 250 (e.g., a first container) with a plurality of troughs 260 and a basin 200 (e.g., a second container). The growing system 10 may include a plurality of container assemblies 220 stored in a rack assembly 14. In some embodiments, the rack assembly 14 stores the plurality of container assemblies 220 in a vertical manner. Examples of such growing system 10 are detailed further in U.S. patent application Ser. No. 18/349,001 entitled “Methods and Apparatus or Indoor Farming,” the contents of which are incorporated herein by reference in its entirety.

With reference to FIG. 3B, the tray 250 includes at least one trough 260 that contains a solid growth medium 18 and at least one germinated plant 22. In the illustrated embodiment, the germinated plant 22 includes a plurality of roots 26 extending through an aperture 264 formed in a bottom surface 268 of the trough 260. A distal portion 30 of the roots 26 extends through and is spaced from the bottom surface 268 of the tray 250. In the illustrated embodiment, FIG. 3B is representative of an early stage in the growing cycle of the germinated plant 22.

With reference to FIG. 3B, the basin 200 includes a bottom wall 210 and side walls 214. An aqueous growth medium 34 is positioned within the basin 200, with a surface 36 of the aqueous growth medium 34 exposed. An aqueous growth medium level 40 is a distance from the bottom wall 210 to the surface 36 of the aqueous growth medium 34.

The tray 250 with the germinated plant 22 is positioned on top of the basin 200. In other words, the tray 250 and the germinated plant 22 are positioned relative to the basin 200 such that an air gap 44 is present between the bottom surface 268 of the tray 250 and the surface 36 of the aqueous growth medium 34. In the illustrated embodiment, the tray 250 includes a lip 254 that abuts an upper surface 218 of the side wall 214. In some embodiments, the tray 250 directly contacts the basin 200. In other embodiments, the tray 250 is coupled to the basin 200 through one or more intervening components. In the illustrated embodiment, the position of the tray 250 relative to the basin 200 is fixed and does not change during the growth cycle of the germinated plant 22. In the illustrated embodiment, the sum of the air gap 44 and the aqueous growth medium level 40 is the distance between the bottom wall 210 of the basin 200 and the bottom surface 268 of the tray 250.

With reference to FIG. 3C, the plant 22 is illustrated in a later stage of the growing cycle with a lesser amount of the aqueous growth medium 34 remaining in the basin 200. In other words, in a later stage of the growing cycle, a portion of the aqueous growth medium 34 has been utilized by the plant 22 resulting in a drop in the surface 36 the aqueous growth medium 34. A reduction in the aqueous growth medium 34 remaining in the basin 20 results in a reduced aqueous growth medium level 40 and an increase in the size of the air gap 44. As detailed further herein, the air gap 44 is advantageously maintained during the growth cycle of the plant 22. In the illustrated embodiment, the plant 22 includes a plurality of roots 26 having a first zone of roots 26A with increased root hair development that is positioned out of the aqueous growth medium 34. The plurality of roots 26 further includes a second zone of roots 26B that is positioned in the aqueous growth medium 34.

Additionally, analysis

### 4. EXAMPLES

It will be readily apparent to those skilled in the art that other suitable modifications and adaptations of the methods of the present disclosure described herein are readily applicable and appreciable, and may be made using suitable equivalents without departing from the scope of the present disclosure or the aspects and embodiments disclosed herein. Having now described the present disclosure in detail, the same will be more clearly understood by reference to the following examples, which are merely intended only to illustrate some aspects and embodiments of the disclosure, and should not be viewed as limiting to the scope of the disclosure. The disclosures of all journal references, U.S. patents, and publications referred to herein are hereby incorporated by reference in their entireties.

The present disclosure has multiple aspects, illustrated by the following non-limiting examples.

### Example 1

Experiments were conducted to assess the efficacy of the compositions, systems, and methods of the present disclosure. As conveyed in FIGS. 1-6, experiments were conducted to assess the ability of the systems and methods of the present disclosure to enhance root hair growth and development by exposing the roots (i.e., zone of maturation) of various plants to an air gap shortly after germination. Various experimental parameters were tested, including but not limited to, humidity of the air gap, size of the air gap, and temperature of the air gap, among others.

The experimental setup included testing various leafy green seeds, were germinated in soil-filled, V-shaped troughs until the roots reached about 10 to about 30 mm in length (see, e.g., FIG. 1). The lid was joined to individual basins with an initial air gap of about 5 mm to 10 mm. The humidity was maintained about 85% using a custom thermoformed container that provided a large overlapping lip between the tray and basin (see, e.g., FIG. 2). The temperature was maintained between about 17° C. and about 25° C. throughout the growing experiments. As shown in FIG. 3A-3C, each of the plurality of plants tested were allowed to germinate such that the roots extended through the bottom of the container and into a growing solution below, with the more proximal portions of the roots exposed to the air gap (see, e.g., FIGS. 3A-3B).

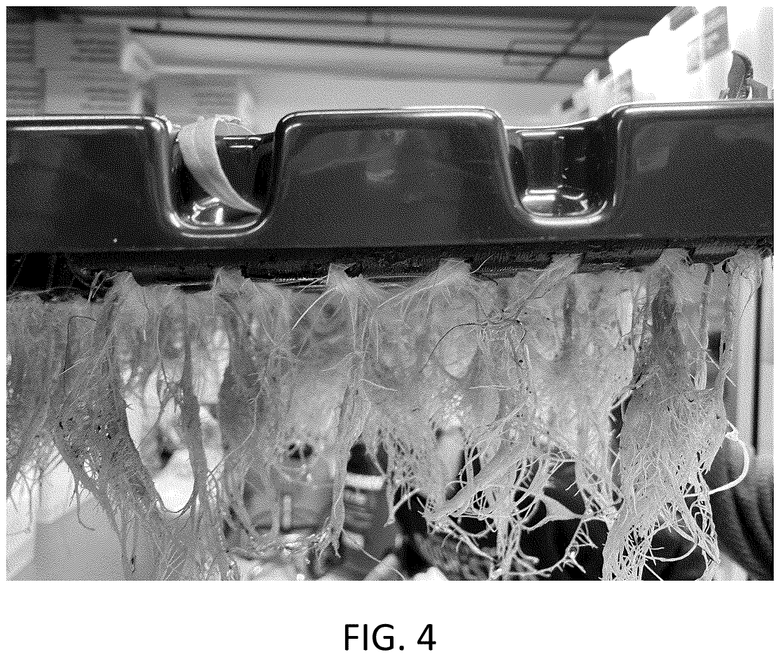

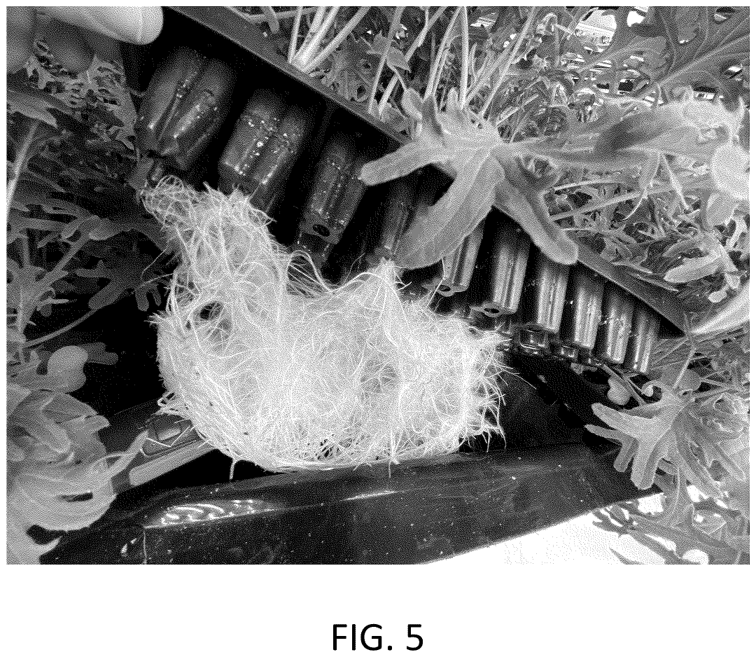

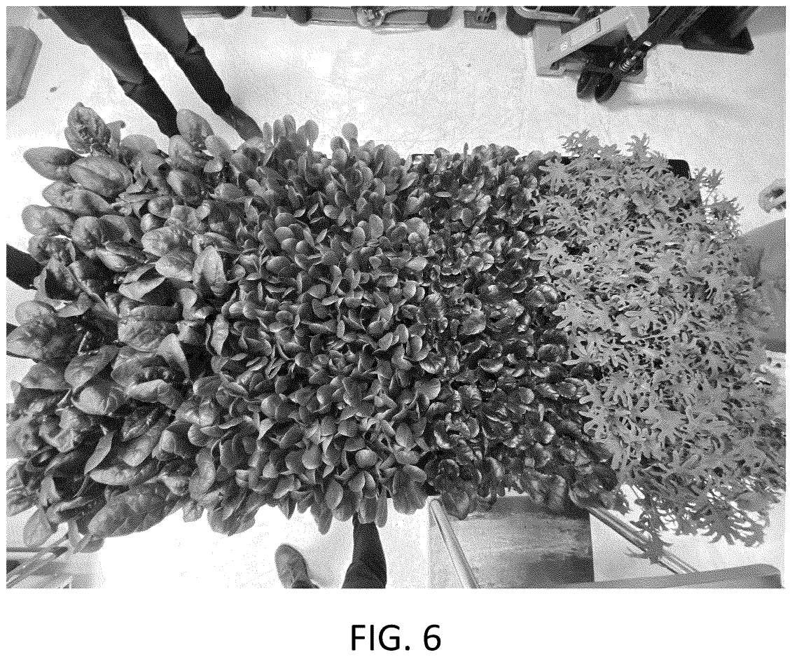

After the initial setup, the growth of the plants led to absorption of the water below the air gap, such that the air gap increased, thus exposing more of the proximal portions of the roots to higher oxygen levels in the air gap. Additionally, the water below the air gap was not circulated, re-circulated, or agitated in any manner (i.e., hydrostatic cultivation), which is a significant distinguishing feature of the systems and methods of the present disclosure. As demonstrated in FIGS. 4 and 5, somewhat unexpectedly, exposure of the roots (i.e., the zone of maturation) to the air gap leads to significantly increase root hair development, which allowed for accelerated growth of the plants. Plants reached harvest size about 21 days after seeding (see, e.g., FIG. 6), which was approximately 7 days earlier than plants grown in conventional flood and drain hydroponic systems that were run in the same environment.

### Example 2

Experiments were also conducted to assess whether the systems and methods of the present disclosure reduced the prevalence and spread of disease among plants grown in a vertical farming and/or hydroponic environment. As shown in FIGS. 7A-7B, results of these experiments demonstrated the unexpectedly beneficial use of the systems and methods of the present disclosure for reducing disease contamination and spreading of various pathogens due to the lack of water circulation among the containers.

The experimental setup included growing spinach seedlings in individual, non-circulating containers. Spinach plants are particularly susceptible to disease spread from, for example, adult plants to seedlings. More specifically, individual containers were inoculated with various different waterborne pathogens common to spinach that quickly spread in greenhouses and vertical farming and hydroponic systems that rely on circulating water. The inoculated plants showed signs of infection (see, e.g., FIG. 7A; yellowing and stunted growth). However, somewhat unexpectedly, other containers immediately adjacent to an infected container remained healthy and no pathogens were detected. Quantification of these results was obtained using DMA Multiscan technology.

As would be readily appreciated by one of ordinary skill in the art, hydroponic spinach production on any scale has been particularly limited because of a water-born oomycete pathogen called Pythium aphanadermatum. This has necessitated the use of costly and complex mitigation strategies to manage the risk of this pathogen to the point where experts insist that unless mitigation strategies are in used to avoid P. aphanadermatum infection and resulting damage, any attempts to grow spinach using the standard methods used for other leafy crops will result in the loss of the spinach crop (see, e.g., see, e.g., Cornell Controlled Environmental Agriculture: Hydroponic Spinach Production Handbook; Brechner and de Villiers, 2013, Cornell University CEA Program). However, as shown in FIGS. 7A-7B, the systems and methods of the present disclosure do not rely on circulating water, which significantly reduces or eliminates rates of fungal infection, including P. aphanidermatum, as compared to the other plants/containers that require circulating water (FIG. 7B). These results clearly demonstrate the efficacy of the systems and methods of the present disclosure to prevent and/or mitigate disease contamination among plants in a vertical farming environment.

1. A method for vertical farming, the method comprising:
obtaining at least one germinated plant, wherein the at least one germinated plant is housed in a first container with solid growth medium, and wherein a distal portion of the roots of the at least one germinated plant extends through a bottom of the first container; and
positioning the first container and the at least one germinated plant relative to a second container with an aqueous growth medium such that an air gap is present between the bottom of the first container and a surface of the aqueous growth medium.

2. The method of claim 1, wherein the at least one germinated plant has been allowed to germinate for between about 2 and about 7 days.

3. The method of claim 1, wherein the distal portion of the roots of the at least one germinated plant is in contact with the aqueous growth medium in the second container or are less than 5 mm from contacting the aqueous medium in the second container.

4. The method of claim 1, wherein the distal portion of the roots of the at least one germinated plant extends from about 10 mm to about 50 mm below the bottom of the first container such that the zones of maturation of the roots are exposed to the air gap.

5. The method of claim 1, wherein the air gap formed between the bottom of the first container and the surface of the aqueous solution is from about 1 mm to about 50 mm.

6. The method of claim 1, wherein the air gap formed between the bottom of the first container and the surface of the aqueous solution is from about 1 mm to about 10 mm.

7. (canceled)

8. The method of claim 1, wherein the solid growth medium is from about 2 cm to about 6 cm deep, and from about 1 cm to about 3 cm wide.

9-10. (canceled)

11. The method of claim 1, wherein the air gap is maintained at a humidity level that is about 60% to about 100% relative humidity.

12-14. (canceled)

15. The method of claim 1, wherein the air gap is maintained during the growth cycle of the at least one germinated plant, and wherein the growth cycle of the at least one germinated plant is from about 10 days to about 25 days.

16. The method of claim 1, wherein the aqueous growing medium comprises an oxygen level that is 10 ppm or less.

17-19. (canceled)

20. The method of claim 1, wherein the aqueous growth medium comprises a pH from about 5.0 to about 8.0.

21-23. (canceled)

24. The method of claim 1, wherein the aqueous growth medium is not circulated, recirculated, or agitated during growth of the at least one germinated plant.

25-26. (canceled)

27. The method of claim 1, wherein the solid growth medium comprises a wetting agent.

28. (canceled)

29. The method of claim 1, wherein the solid growth medium comprises a fungal agent.

30-32. (canceled)

33. The method of claim 1, wherein the ambient temperature surrounding the first container and the second container is maintained at about 15° C. to about 25° C.

34. (canceled)

35. The method of claim 1, wherein the method further comprises replacing and/or replenishing the aqueous growth medium at least once during growth of the at least one germinated plant.

36-37. (canceled)

38. The method of claim 1, wherein the method further comprises transferring the at least one germinated plant to at least a third container containing aqueous growth medium.

39-40. (canceled)

41. The method of claim 1, wherein the method further comprises assessing at least one growth parameter during growth of the at least one germinated plant.

42. The method of claim 1, wherein the method further comprises harvesting the at least one germinated plant when a desired growth outcome is reached.

43. The method of claim 1, wherein the at least one germinated plant is selected from the group consisting of: bok choy, pac choi, lettuce, spinach, chard, kale, arugula, mustard greens, fennel, basil, chives, mint, parsley, cilantro, tomatoes, cucumbers, broccoli, peas, strawberries, rice, quinoa, mushrooms, and/or flowering plants.
